(19) United States
(12) Patent Application Publication
(10) Pub. No.: US 2010/0284440 A1
(43) Pub. Date: Nov. 11, 2010

(54) Time-Multiplexed Binary Offset Carrier Signaling and Processing

(75) Inventors: John W. BETZ, Bedford, MA (US); Christopher J. Hegarty, Westford, MA (US); Joseph J. Rushanan, Bedford, MA (US)

Correspondence Address: STERNE, KESSLER, GOLDSTEIN & FOX P.L.L.C., 1100 NEW YORK AVE., N.W., WASHINGTON, DC, 20005, US

(73) Assignee: The MITRE Corporation, McLean, VA (US)

(21) Appl. No.: 12/755,933

(22) Filed: Apr. 7, 2010

Related U.S. Application Data
(62) Division of application No. 11/785,571, filed on Apr. 18, 2007, now abandoned.

(51) Int. Cl. H04B 1/707

(52) U.S. Cl. 375/146; 375/E01.002

(57) ABSTRACT

Methods and systems for direct sequence spread spectrum (DSSS) signals are described herein. In an embodiment, a DSSS signal includes a time multiplexed spreading time series. The time multiplexed spreading time series includes a data spreading time series includes at least a first spreading symbol, and a pilot spreading time series includes at least a second spreading symbol and a third spreading symbol. The second spreading symbol and the third spreading symbol are different.

### CROSS-REFERENCE TO RELATED APPLICATIONS

This application is a divisional of U.S. Non-Provisional Application No. 11/785,571, filed Apr. 18, 2007, which is incorporated herein in its entirety by reference.

### STATEMENT REGARDING FEDERALLY-SPONSORED RESEARCH AND DEVELOPMENT

The U.S. government has a paid-up license in this invention and the right in limited circumstances to require the patent owner to license others on reasonable terms as provided for by the terms of Contract No. FA8721-06-C-0001 awarded by the United States Air Force.

### BACKGROUND OF THE INVENTION

1. Field of the Invention

The present invention relates generally to wireless telecommunications and satellite radionavigation, and more particularly to systems that employ direct sequence spread spectrum communications signaling.

2. Background Art

The Global Navigation Satellite System (GNSS) allows for the location of a user to be determined virtually anywhere in the world. GNSS operations have found a multitude of civilian and military applications.

GNSS components allow a user's position to be determined based on signals received from a number of visible satellites (typically four or more) through the use of a user terminal. The Global Positioning System (GPS) in the United States and the Galileo system in Europe are two existing or planned GNSS components. An agreement between the United States and Europe to strive for mutually compatible and interoperable GNSS components helped to define the baseline signals used commonly between GPS and Galileo, but left open the possibility for signal optimization.

What are needed are methods and systems that optimize GNSS signals while remaining within the bounds set by the agreement between the United States and Europe.

### BRIEF SUMMARY OF THE INVENTION

The invention is directed to methods, systems, and computer program products for direct sequence spread spectrum (DSSS) signals.

In an embodiment, a DSSS signal includes a time-multiplexed spreading time series. The time-multiplexed spreading time series includes a data spreading time series comprising at least a first spreading symbol, and a pilot spreading time series comprising at least a second spreading symbol and a third spreading symbol. The second spreading symbol and the third spreading symbol are different.

In another embodiment, the invention is directed to a method of generating a DSSS signal that includes generating a data spreading time series comprising at least a first spreading symbol, generating a pilot spreading time series comprising at least a second spreading symbol and a third spreading symbol, and forming the DSSS signal based at least on the data spreading time series and the pilot spreading time series. The second spreading symbol and the third spreading symbol are different.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a spread spectrum communication environment according to an embodiment of the invention.

FIGS. 2A and 2B illustrate exemplary orthogonal wavefoims according to an embodiment of the invention.

FIG. 3 illustrates a CDMA communication environment according to an embodiment of the invention.

FIGS. 4A-4D illustrate example waveforms used to communicate in a CDMA system according to an embodiment of the invention.

FIGS. 5 and 6 illustrate exemplary waveforms corresponding to binary offset carrier spreading symbols according to an embodiment of the invention.

FIGS. 7 and 8 illustrate power spectral density plots for different spreading modulations according to an embodiment of the invention.

FIG. 9 illustrates an exemplary spreading time series according to an embodiment of the present invention.

FIG. 10 illustrates another spreading time series according to an embodiment of the present invention.

FIG. 11 illustrates waveforms corresponding to autocorrelation functions for different spreading time series according to an embodiment of the present invention.

FIG. 12 illustrates waveforms corresponding to error envelope functions for different spreading time series according to an embodiment of the present invention.

FIG. 13 illustrates waveforms corresponding to average worst-case error functions for different spreading time series according to an embodiment of the present invention.

FIG. 14 illustrates waveforms corresponding to error envelope functions for different spreading time series with double delta processing according to an embodiment of the present invention.

FIG. 15 illustrates waveforms corresponding to average worst-case error functions for different spreading time series with double delta processing according to an embodiment of the present invention.

FIG. 16 illustrates a process flowchart for generating a direct sequence spread spectrum (DSSS) signal according to an embodiment of the present invention.

FIG. 17 illustrates a correlation receiver according to an embodiment of the present invention.

FIG. 18 illustrates a matched filter receiver according to an embodiment of the present invention.

FIG. 19 illustrates a process flowchart for receiving a DSSS signal according to an embodiment of the present invention.

FIG. 20 illustrates cross-correlation sidelobes for different spreading time series according to an embodiment of the present application.

FIG. 21 illustrates autocorrelation sidelobes according for different spreading time series to an embodiment of the present application.

The present invention will be described with reference to the accompanying drawings. Generally, the drawing in which an element first appears is typically indicated by the leftmost digit(s) in the corresponding reference number.

### DETAILED DESCRIPTION OF EMBODIMENT(S)

### Introduction

Spread Spectrum Communications

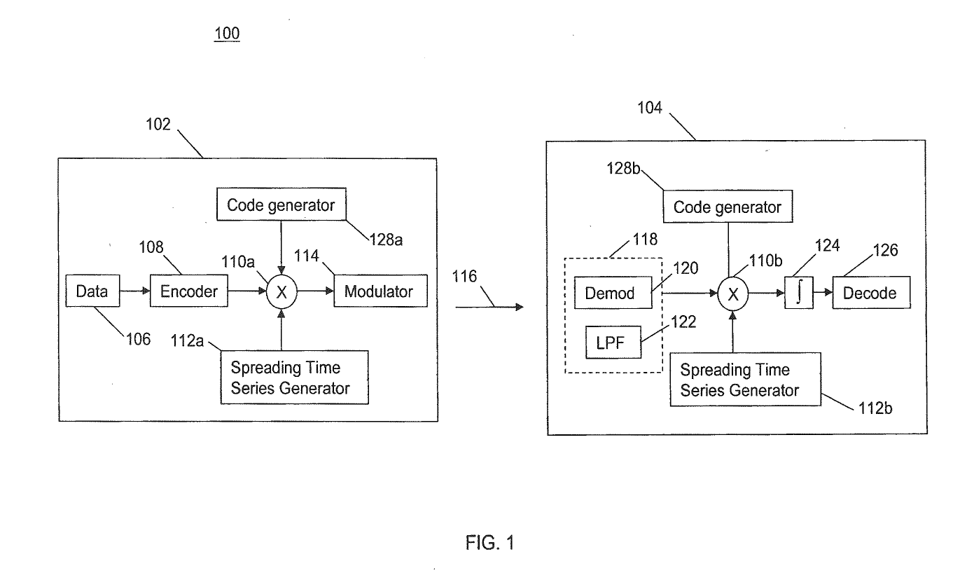

Spread spectrum communications provide for efficient rejection of interference that often hampers wireless communications. A block diagram of an exemplary spread spectrum communication system 100 is shown in FIG. 1. Communication system 100 may be a wireless communication system such as but not limited to a Bluetooth communication system, a satellite communication system, a wireless local area network (WLAN), etc. Communication system 100 includes a transmitter 102 and a receiver 104. In alternate systems, transceivers, i.e., devices that include components configured to transmit and receive communications, may be used.

Transmitter 102 includes a data device 106, an encoder 108, a multiplier 110a, a spreading time series generator 112a, a pseudo-random code generator 128a, and a modulator 114. Transmitter 102 generates a signal 116, which is received by receiver 104. In the embodiment where receiver 104 is a transceiver, receiver 104 may also transmit signals to transmitter 102. Receiver 104 includes a detector 118, a multiplier 110b, a spreading time series generator 112b, a pseudo-random code generator 128b, an integrator 124, and a decoder 126.

Data device 106 may be a computer processing unit, microcontroller, or other device that generates a baseband data signal. The baseband signal may, for instance, be information that is to be transmitted to receiver 104. The baseband signal may include a plurality of symbols. In such an embodiment, a symbol may be a plurality of bits that have a specific meaning to an intended receiver. The baseband data signal is communicated to encoder 108. Encoder 108 encodes the information contained in the baseband signal according to an encoding algorithm, such as but not limited to non-return to zero coding, an error correcting coding, or other coding as would be apparent to persons skilled in the relevant art(s). Encoder 108 outputs the encoded data to multiplier 110a. Multiplier 110a multiplies the encoded data signal with a spreading time series generated by spreading time series generator 112a. The spreading time series may be configured to increase a total bandwidth used by the encoded data signal. In an embodiment, the spreading time series may be expressed as:

$$s ( t ) = {\sum }_{k = - ∞}^{∞} {g}_{k} ( t - {kT}_{c} ) \qquad Equation 1$$

where s(t) is the spreading time series,

{gₖ(t−kT_{c})} are a series spreading symbols, and

T_{c} is a period of a spreading symbol.

Spreading time series s(t) includes a plurality of chips. A spreading time series as described herein is defined as a deterministic time series produced with chip values formed by a series of spreading symbols. Typical spreading symbols are non-zero only over the interval [0, T_{c}). Accordingly, those skilled in the art would recognize that the sum of Equation 1 may reduce to only one non-zero term at a given time t. The product of the spreading time series and the encoded data signal is also multiplied with a pseudo-random code generated by pseudo-random code generator 128a. The pseudo-random code may be a periodic sequence generated by any of a multitude of pseudo-random algorithms, as would be appreciated by persons skilled in the relevant art(s), and may be configured to be interpreted as noise by any unintended recipient of signal 116.

Spreading symbols {gₖ(t)} may be a variety of different types of symbols. For example, the binary phase shift keyed (BPSK) spreading symbol has a constant value for all chips. Multiplier 110a then outputs the product of the spreading time series, the encoded data signal, and the pseudo-random code. Modulator 114 modulates the product. In an embodiment, modulator 114 may modulate the product signal according to a commonly known modulation technique, such as but not limited to phase shift keying, quadrature amplitude modulation, etc. In an embodiment where the product is binary, binary versions of the aforementioned techniques may be used. In an embodiment, modulator 114 may output a modulated signal to an antenna (not shown in FIG. 1) that generates signal 116. The product may also be modulated according to a time multiplexing or phase multiplexing technique, combined with other signal components using a linear combining technique or a non linear technique such as majority voting, or an interplexing technique, as would be appreciated by those skilled in the relevant art(s).

Signal 116 is received at receiver 104. Received signal 116 is applied to detector 118. In an embodiment, detector 118 is a coherent detector and includes demodulator 120 and low pass filter (LPF) 122. Detector 118 demodulates received signal 116 and outputs a demodulated signal. The demodulated signal is then multiplied with a second pseudo-random code generated by pseudo-random code generator 128b and a second spreading time series generated by second spreading time series generator 112b by multiplier 110b. Multiplier 110b is substantially similar to multiplier 110a in transmitter 102. Spreading time series generator 112b is substantially similar to spreading time series generator 112a in transmitter 102. In an embodiment, spreading time series generator 112b generates a spreading time series that is identical to the spreading time series generated by spreading time series generator 112a. Pseudo-random code generator 128b is substantially similar to pseudo-random code generator 128a. In an embodiment, pseudo-random code generator 128b generates a pseudo-random code that is substantially identical to the pseudo-random code generated by pseudo-random code generator 128a. In a further embodiment, spreading time series generator 112b and pseudo-random code generator 128b are synchronized with spreading time series generator 112a and pseudo-random code generator 128a, respectively.

Multiplying the demodulated signal with the spreading time series at multiplier 110b effectively despreads the received signal (i.e., reverses the effects of the spreading time series). The product of the demodulated signal, the second pseudo-random code, and the second spreading time series is then applied to integrator 124 that integrates the product signal over a bit period and outputs the result to decoder 126. Decoder 126 attempts to reproduce the original data signal based on the result provided by integrator 124. Alternatively, a correlation receiver or matched filter receiver may also be used to despread and decode the demodulated signal. The operation of such a correlation receiver or matched filter receiver will be described later herein.

Transmitter 102 in FIG. 1 shows data device 106 and encoder 108. In GNSS signals that include a pilot component, the pilot component may also be generated by a transmitter substantially similar to transmitter 102 except that both data device 106 and encoder 108 would be replaced by an overlay code generator. Thus, the overlay codes generated by the overlay code generator would represent the informational content contained in signal 116. In signals that contain both pilot and data components, the pilot and data components may be multiplexed together using a time multiplexing or phase multiplexing technique, combined with other signal components using a linear combining technique or a non linear technique such as majority voting, or an interplexing technique, as would be appreciated by those skilled in the relevant art(s).

Multiple Access Techniques

FIG. 1, as just described, shows communication between a single transmitter 102 and a single receiver 104. In alternate embodiments, communications may occur between many different entities in a communication network. In response to such multiple access demands, many different multiple access schemes have been developed, such as frequency-division multiple access (FDMA), time-division multiple access (TDMA), and code-division multiple access (CDMA). In FDMA, different users or groups of users are allotted distinct frequency bands within the total available bandwidth of the communication network. In such a scheme, users can communicate at any time, but are restricted to using a subset of the total system bandwidth. In TDMA, different users in the communication network are allotted different times in which they can communicate, but are allotted the entire bandwidth of the communication system during their allotted time.

In CDMA, the resources of a communication network are shared both in terms of frequency and time. This allows the resources of the communication network to be used more efficiently. Ideally, users in a CDMA network are assigned a vector from a set of orthogonal vectors. At some point after generating a data stream to be transmitted to a receiver, the transmitter applies the data stream to the vector assigned to the receiver.

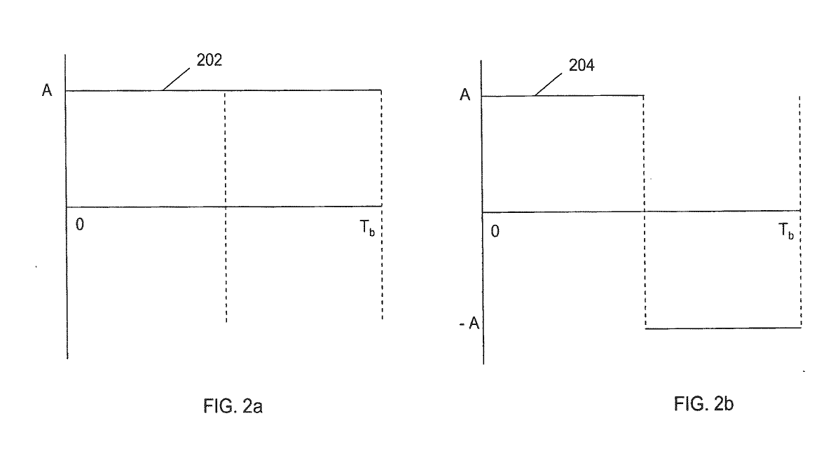

FIGS. 2A and 2B show exemplary binary orthogonal waveforms 202 and 204. For reference purposes, assume waveform 202 represents a vector v₁ and waveform 204 represents a vector v₂. A dot product between v₁ and v₂ (useful to compare vectors v₁ and v₂) is defined as:

$${\int }_{0}^{{T}_{b}} {v}_{1} ( t ) {v}_{2} ( t ) d t , \qquad Equation 2$$

where T_{b} is the bit period of the vectors v₁ and v₂.

A pair of orthogonal vectors is described herein as two vectors that have a dot product of zero between them. For example, vectors V₁ and v₂ as represented by waveforms 202 and 204 are orthogonal.

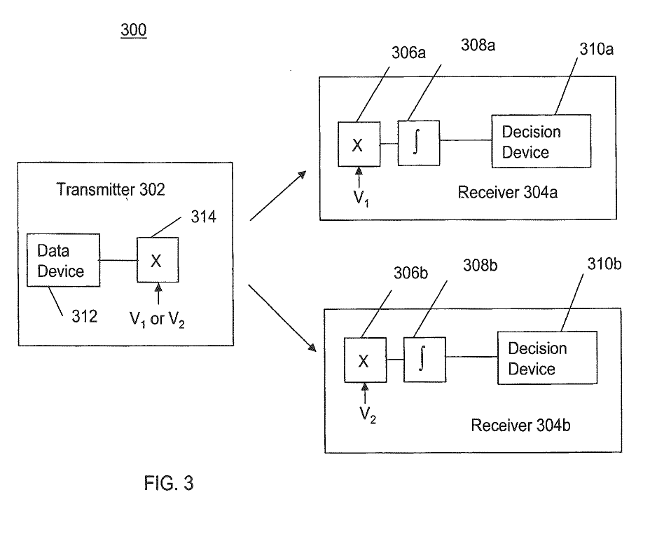

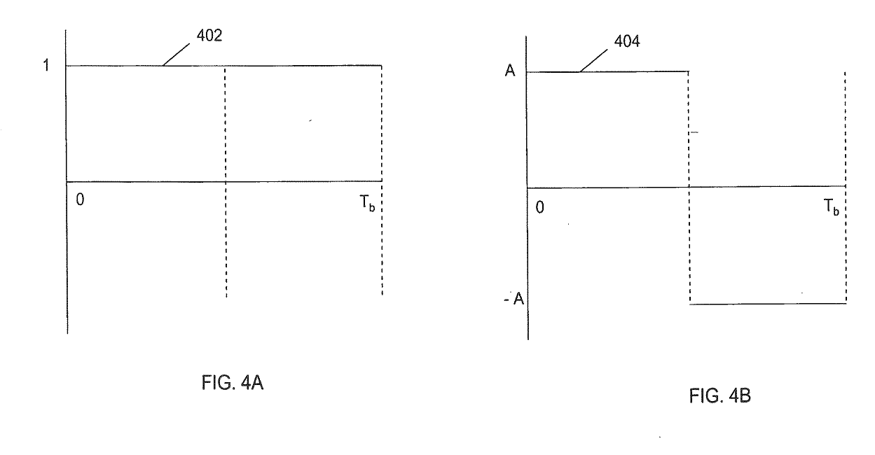

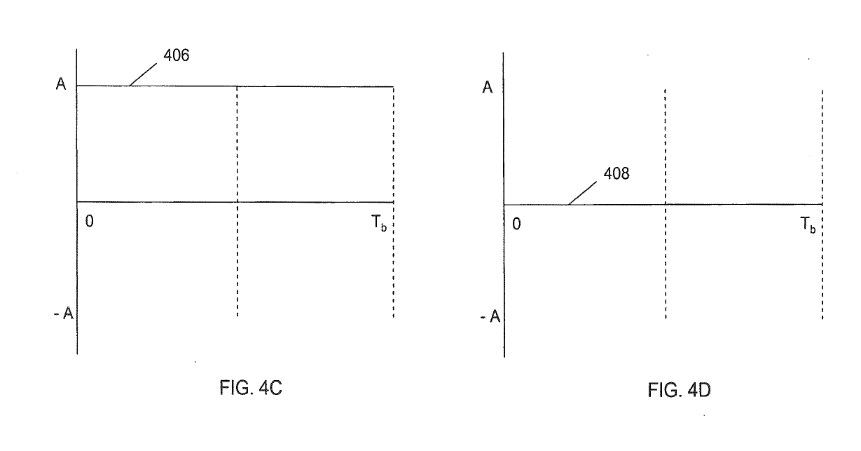

FIG. 3 shows an example CDMA communications system 300. Communications system 300 includes a transmitter 302, a first receiver 304a and a second receiver 304b. Transmitter 302 includes a data device 312 and a multiplier 314. Multiplier 314 may be used to apply a vector onto a digital stream. First receiver 304a includes a multiplier 306a, an integrator 308a, and a decision device 310a. Similarly, second receiver 304b includes a multiplier 306b, an integrator 308b, and a decision device 310b. In an embodiment, first receiver 304a is assigned vector v₁ and second receiver 304b is assigned vector v₂. The operation of communications system 300 will be described with reference to FIGS. 4A-4D. FIGS. 4A-4D show an exemplary communication in which transmitter 302 intends to send data to receiver 304b.

FIG. 4A shows a waveform 402 that corresponds to a signal generated by transmitter 302. In an embodiment, waveform 402 may correspond to a binary logic 1. Waveform 402 is generated by data device 312.

FIG. 4B shows a waveform 404 corresponding to the binary logic 1 represented by vector v₂. Waveform 404 is formed by multiplying waveform 402 (that was output by data device 312) and vector v₂ at multiplier 314. Vector v₂ is chosen because transmitter 302 intends for receiver 304b to receive the binary logic 1. If, instead, receiver 304a had been the intended recipient, transmitter 302 would have multiplied waveform in 402 with vector v₁

Receiver 304b receives waveform 404 (after suitable modulation by the transmitter 302, and demodulation by the receiver 304b), and multiples waveform 404 by vector v₂. FIG. 4C shows waveform 406 corresponding to the product of waveform 404 and vector v₂. Waveform in 406 is then integrated by integrator 308b over the bit period T_{b}. The result of the integration is output to decision device 310a that infers the intended message of transmitter 302 from the result of the integration.

Receiver 304a also may receive waveform 404. FIG. 4D shows waveform 408 corresponding to the product of waveform 404 and vector v₁. Integration over bit period T_{b} would result in a value substantially close to zero. It would be understood by those skilled in the relevant arts that all signals represented by vector v₂ would result in a waveform substantially identical to waveform 408 when multiplied by vector v₁.

In an embodiment, decision devices 310a and 310b use a positive threshold above which a value is inferred to be a logic 1 and a negative threshold below which a value is inferred to be a logic 0. In such an embodiment, transmitter 302 transmits a stream of binary values (including both binary logical 1s and 0s) represented by forms of vector v₂. Upon receiving the signal, receiver 304b multiplies the signal with vector v₂ and integrates the product during each bit period. Since vector v₂ is used at receiver 304b, the series of integrations would lead to a series of values above the positive threshold and below the negative threshold. Values at or above the positive threshold would correspond to logical 1s and values below the negative threshold would correspond to logical 0s. In contrast, receiver 304a, would multiply the received signal with vector v₁ and also integrate over successive bit periods. Such integration would lead to values that are between the positive and negative thresholds. Such values correspond to neither logical is nor logical 0s. Based on this, receiver 304a would determine that the signal was not intended for it.

Those skilled in the relevant art(s) would appreciate that the reverse would apply to signals that are represented by vector v₁.

In alternate embodiments, decision devices 310a and 310b may use a negative threshold below which a value is inferred to be a logic 1 and a positive threshold above which a value is inferred to be a logic 0.

As shown from the above discussion, orthogonality between signals can be used to efficiently communicate through a CDMA network while ensuring that unintended recipients do not receive the transmitted message. An autocorrelation function between a signal and a time shifted version of the signal and a cross-correlation function between different signals help to measure the orthogonality of signals transmitted within a CDMA network. Often, in complicated networks, perfect orthogonality cannot be attained. In such a case, autocorrelation and cross-correlation functions become important in evaluating different communication algorithms for CDMA systems. In spread spectrum systems that include data symbols in a spreading time series, achieving approximate orthogonality is an important design criteria in selecting a spreading time series.

Global Navigation Satellite System

GNSS components, such as GPS, typically employ techniques similar to spread spectrum CDMA communication systems. Many different types of modern GNSS signals exist. These signals typically include a data component which carries information such as timing information, information used to calculate a position of a satellite, and other information such as satellite status. Some GNSS signals also include a pilot component. The pilot component does not contain information, but rather is often used in signal tracking by the receiver. The pilot component does not contain data symbols. Signal tracking refers to the estimation of the timing features of the received signal so that the receiver can successfully despread the incoming signal, demodulate data, and generate pseudorange and carrier-phase measurements. Each of these two components may be modulated separately before the entire signal is modulated to a carrier frequency that eventually carries the signal to the intended destination. A GNSS signal may also include other components as would be apparent to those skilled in the relevant art(s). Moreover, as would also be appreciated by those skilled in the relevant art(s), a GNSS signal may include more than one data component and/or more than one pilot component.

In the case of GNSS signals, each of the data and pilot components can be formed based on an independent spreading time series.

In the following section, embodiments of the present invention are described. These embodiments include methods and systems to modulate signals, where such methods and systems are compliant with current United States/European agreements relating to the use of mutually compatible and interoperable GNSS components.

### Methods and Systems for Spreading Modulation of GPS Signals

As discussed above, in spread spectrum communications, a spreading time series may be generated. Ideally this spreading time series results in a spread spectrum signal that is approximately orthogonal to other signals, and to time shifted versions of itself. The spreading time series includes a plurality of chips, with each chip including a spreading symbol. The period of a chip, T_{c}, is typically smaller than the period of the encoded data signal, T_{b}. Thus a single data symbol may be multiplied with multiple chips. In an embodiment where Tᵢ, is an integer multiple of T_{c} an integer number of chips are multiplied with a single data symbol. For example, an example spreading rate is 1.023 MHz, which results in a spreading period, T_{c} of about 1 μs.

Also noted above, a spreading time series can be described in general as:

$$s ( t ) = {\sum }_{k = - ∞}^{∞} {g}_{k} ( t - {kT}_{c} ) \qquad Equation 1$$

In a relatively simple case, g(t)=±1 over kT_{c}≦t≦(k+1)T_{c} (i.e., a BPSK spreading symbol), so that s(t)=±1 over the entire spreading time series. While it has been recognized that adequate performance can be obtained using BPSK spreading symbols, the use of such symbols leads to power spectral densities that have a relatively higher amount of total signal power located close to the carrier frequency. It has been recognized that better performance may be realized by using a spreading time series that has more of the total power of the GNSS signal allocated at frequencies with greater separation from the carrier frequency.

Binary Offset Carrier (BOC) spreading symbols consist of one or more periods of a rectangular wave over the duration of a chip. Different types of BOC symbols are typically abbreviated as BOC(n,m), were n corresponds to a rate of a rectangular wave and m corresponds to a rate of a pseudo-random code applied to the spreading symbol. In an embodiment, n and m are coefficients of a 1.023 MHz frequency. For example, a BOC(6,1) spreading symbol corresponds to a rectangular wave frequency of 6.138 MHz with an applied pseudo-random code rate of 1.023 MHz. In a further embodiment in which the width of a chip corresponds to a frequency of 1.023 MHz (about 1 μs), an integral number of periods of the rectangular wave are included in a single chip. Moreover, in a case where a BOC(n,1) spreading symbol is used, a single symbol of the pseudo-random code is applied to the entire chip.

For example, a BOC(1,1) spreading symbol may be expressed as:

$$g ( t ) = \{ \begin{matrix}sgn [ sin ( 2 π t / {T}_{c} ) ] 0 \leq t \leq {T}_{c} \\ 0\end{matrix} \qquad Equation 3$$

A BOC(6,1) spreading symbol may be expressed as:

$$g ( t ) = \{ \begin{matrix}sgn [ sin ( 12 π t / {T}_{c} ) ] 0 \leq t \leq {T}_{c} \\ 0\end{matrix} \qquad Equation 4$$

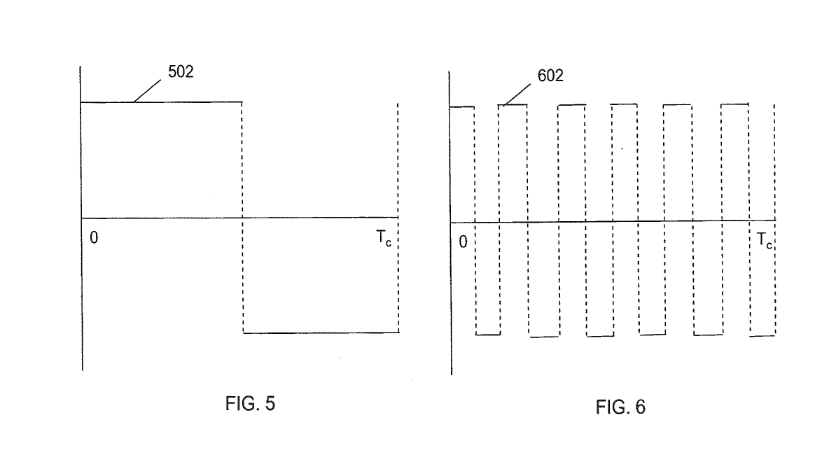

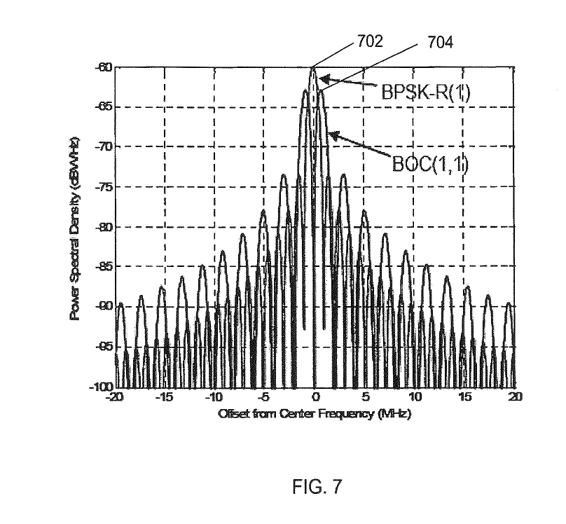

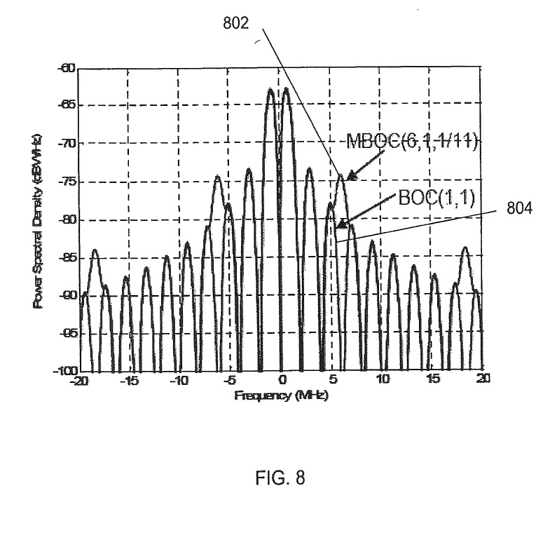

FIGS. 5 and 6 show waveforms 502 and 602 corresponding to BOC(1,1) and BOC(6, 1) spreading symbols as defined in Equations 3 and 4 respectively. As shown in FIGS. 5 and 6, there is one period of a rectangular wave in a BOC(1,1) spreading symbol per chip period T_{c}, and six periods of a rectangular wave in a BOC(6,1) spreading symbol per chip period T_{c}. As shown in FIGS. 5 and 6, spreading symbols BOC(1,1) and BOC(6,1) have identical amplitudes and phase and only differ in the frequency of the rectangular wave.

As mentioned above, high frequency content in a baseband GNSS signal often leads to improved performance. In particular, such high frequency content may improve signal tracking accuracy in noisy and multipath environments. The use of a spreading time series that incorporates BOC spreading symbols helps to incorporate such high frequency content. A BOC spreading symbol is a higher frequency spreading symbol than a BPSK spreading symbol. In other words, the BOC spreading symbol has more transitions in a given time than does a BPSK spreading symbol. BOC spreading symbols also are said to have more high frequency content than do BPSK spreading symbols since a larger percentage of total signal power of a spreading time series is located at high frequencies with BOC spreading symbols when compared to BPSK spreading symbols.

FIG. 7 shows waveforms 702 and 704 corresponding to unit-power power spectral densities (PSDs) for spreading modulations based on a BPSK spreading symbol and a unit-power PSD for spreading modulations based on a BOC(1,1) spreading symbol, respectively. As shown in FIG. 7, waveform 704 has more signal power at high frequencies than does waveform 702. Therefore, a spreading time series that includes BOC(1,1) spreading symbols would result in the baseband GNSS signal having more signal power at high frequencies than would a signal resulting from the spreading symbols made up of solely of BPSK spreading symbols. In other words, the addition of BOC(1,1) spreading symbols to a spreading time series made up of entirely BPSK spreading symbols effectively adds high frequency content to the baseband signal. As described above, adding high frequency content improves signal tracking accuracy in noisy and multipath environments.

In an embodiment, more high frequency content can be added to a spreading modulation by including BOC(6,1) spreading symbols. A unit-power PSD of a multiplexed binary offset carrier (MBOC) incorporating both BOC(1,1) and BOC(6,1) spreading symbols may be expressed as:

$${G}_{signal} ( f ) = \frac{10}{11} {G}_{BOC ( 1 , 1 )} ( f ) + \frac{1}{11} {G}_{BOC ( 6 , 1 )} ( f ) , \qquad Equation 5$$

where G_{signal}(f) is the unit-power PSD of the GNSS signal,

G_{BOC (1,1)}(f) is the unit-power PSD of a BOC(1,1) spreading modulation, and

G_{Boc(6,1)}(f) is the unit-power PSD of a BOC(6,1) spreading modulation.

As would be appreciated by persons skilled in the relevant art(s), other MBOC PSDs could also be formed by altering the influence of the BOC(1,1) and BOC(6,1) spreading symbols, adding and/or replacing one or both of the BOC(1,1) or BOC(6,1) spreading symbols, etc. However, the PSD expressed in Equation 5 is a representation of a selection based on practical implementation. Such an MBOC implementation is referred to as a MBOC(6,1,1/11) implementation, because it includes BOC(6,1) spreading symbols that account for 1/11th of the resulting PSD.

FIG. 8 shows waveforms 802 and 804 corresponding to a unit-power

PSD for BOC(1,1) spreading modulation, and a unit-power PSD for an MBOC (6,1,1/11) spreading modulation, respectively. As shown in FIG. 8, waveform 804 has more power at high frequencies than waveform 802. Thus, the addition of BOC(6,1) spreading symbols, as in the MBOC(6,1,1/11) spreading modulation, effectively adds high frequency content to the resulting baseband signal.

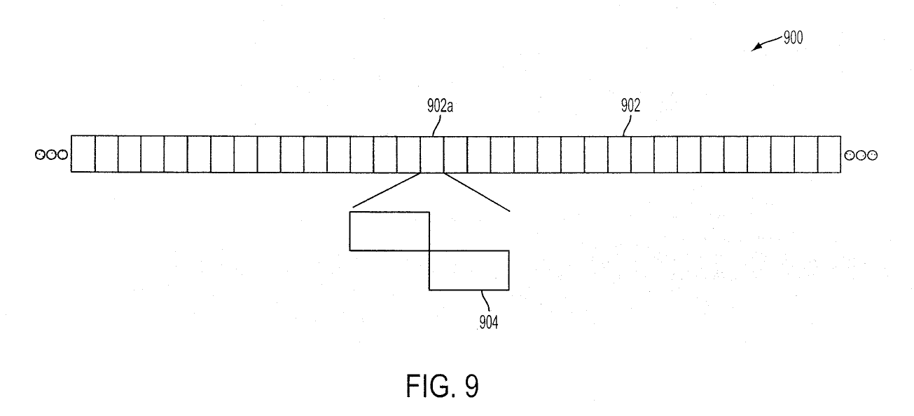

FIG. 9 shows a portion of a spreading time series 900 including a plurality of chips 902. As shown in FIG. 9, chip 902a has a spreading symbol corresponding to a waveform 904. All other chips 902 have the same spreading symbol. In an embodiment, waveform 904 corresponds to a BOC(1,1) spreading symbol as there is one period of a rectangular wave in each chip.

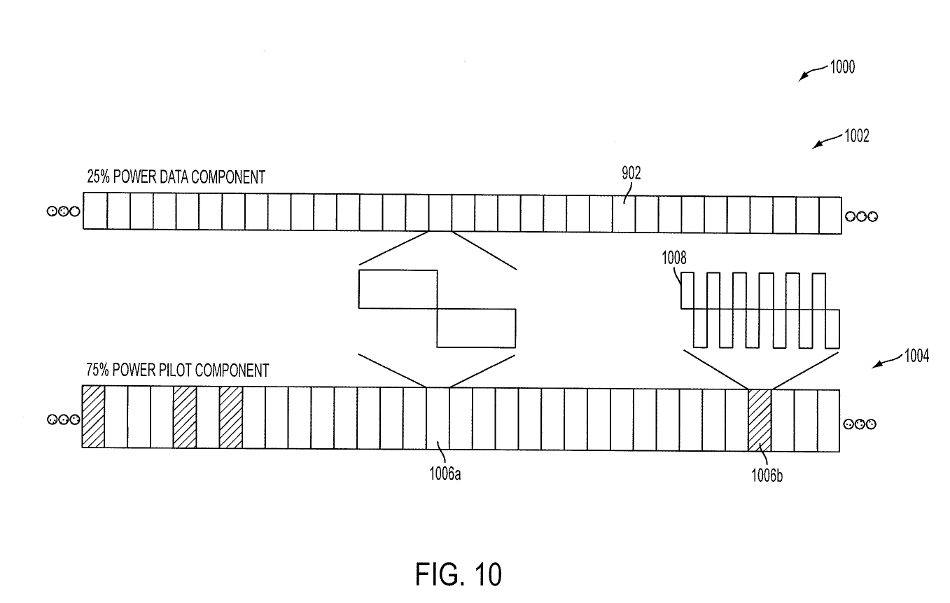

FIG. 10 shows a portion of a spreading time series 1000, according to an embodiment of the present invention. In the embodiment shown in FIG. 10, spreading time series 1000 includes a data spreading time series 1002 and a pilot spreading time series 1004. Data spreading time series 1002 is generally similar to spreading time series 900 shown in FIG. 9. All of the spreading symbols of data spreading time series 1002 are BOC(1,1) spreading symbols. Since the pilot component is used for signal tracking, additional high frequency content in the data component typically does not improve signal tracking as much as inserting the high frequency content into the pilot component of the baseband signal. All of the additional high frequency content in spreading time series 1000 is inserted in the pilot component. In alternate embodiments, high frequency content may also be inserted into the data component.

Pilot spreading time series 1004 includes a plurality of chips 1006. Pilot spreading time series 1004 includes two types of spreading symbols exemplified by chips 1006a and 1006b. Chip 1006a has a BOC(1,1) spreading symbol. In contrast, chip 1006b has a BOC(6,1) spreading symbol corresponding to a waveform 1008. Waveform 1008 includes six periods of rectangular wave within chip 1006b. Spreading time series 1000 may be referred to as a time multiplexed spreading time series, since it includes a blend or mix of different spreading symbols. Moreover, spreading time series 1000 may also be referred to as a time multiplexed BOC(6,1,4/33) (TMBOC(6,1,4/33)) spreading time series since all of the spreading symbols are BOC spreading symbols and four BOC(6,1) spreading symbols are incorporated in the pilot component for every 33 chips in the pilot component. Those skilled in the art would recognize that the TMBOC(6,1,4/33) spreading series shown in FIG. 10 is a single embodiment and other similar spreading time series may be generated without departing from the scope and spirit of the invention. Thus, spreading time series 1000 may be referred to as a single embodiment of a TMBOC spreading time series.

Both data spreading time series 1002 and pilot spreading time series 1004 repeat in the complete spreading time series. As shown in FIG. 10, the BOC(6,1) spreading symbol (shown as shaded spreading symbols) appears in the 1st chip, 5th chip, 7th chip, and 30th chip within pilot spreading time series 1004, while all other chips have the BOC(1,1) spreading symbol. In an embodiment where a spreading time series has a total length of 10230 chips, the pattern shown in FIG. 10 is repeated 310 times. In an embodiment where the total length of a spreading time series is 4092 chips, the pattern shown in FIG. 10 is repeated 124 times.

Several considerations affect the choice of where to insert the high frequency BOC spreading symbols. In an embodiment where high frequency BOC spreading symbols are placed in both data and pilot components, placing the high frequency BOC spreading symbols in corresponding locations in the data and pilot spreading time series (i.e., making the data spreading time series and the pilot spreading time series identical) leads to the simplest receiver implementation. Moreover, proper placement of the high frequency BOC spreading symbols within each of the data and pilot spreading time series also leads to improvement in the spreading time series' autocorrelation and cross-correlation properties.

In alternate embodiments, the locations and total number of the BOC(6,1) spreading symbol may change without departing from the scope and spirit of the invention, as would be appreciated by persons skilled in the relevant art(s).

FIG. 10 shows one embodiment of a TMBOC spreading series. In alternate embodiments, pilot spreading time series 1004 may include other BOC spreading symbols. For example, both the choice of a lower frequency BOC spreading symbol and the higher frequency BOC spreading symbol may be changed. For example, instead of using the BOC(1,1) and the BOC(6,1) spreading symbols, BOC(2,1) and BOC(4,1) spreading symbols may be used. Moreover, any combination of the aforementioned spreading symbols as well as other BOC spreading symbols may also be used.

In the embodiment of FIG. 10, a BOC(n,m) spreading symbol was only altered in terms of the rectangular wave, i.e., only n was changed. However, alternate embodiments may also include signals in which the frequency of the pseudo-random code, i.e., m, may also be changed. Furthermore, in the embodiment of FIG. 10, only two spreading symbols are used. As would be appreciated by those skilled in the relevant art(s), greater than two spreading symbols may be used.

Moreover, FIG. 10 shows an embodiment where the data component of the signal has 25% of the total signal power and the pilot component of the signal has 75% of the total power. In the embodiment in which all of the high frequency BOC symbols are in pilot spreading time series 1004, all of the high frequency content added by including the higher frequency BOC symbols is added to the pilot component of the resulting baseband GNSS signal. In an embodiment, this results in the greatest possible benefit in signal tracking. The unit-power PSD of spreading time series 1000 may be determined as follows:

$$\begin{matrix}{G}_{Pilot} ( f ) = \frac{29}{33} {G}_{BOC ( 1 , 1 )} ( f ) + \frac{4}{33} {G}_{BOC ( 6 , 1 )} ( f ) \\ {G}_{Data} ( f ) = {G}_{BOC ( 1 , 1 )} ( f ) \\ {G}_{TMBOC} ( f ) = \frac{3}{4} {G}_{Pilot} ( f ) + \frac{1}{4} {G}_{Data} ( f ) \\ = \frac{10}{11} {G}_{BOC ( 1 , 1 )} ( f ) + \frac{1}{11} {G}_{BOC ( 6 , 1 )} ( f )\end{matrix} \qquad Equation 6$$

where Gₚᵢₗₒₜ (f) is the unit-power PSD of the pilot spreading modulation,
G_{Data}(f) is the unit-power PSD of the data spreading modulation, and
G_{TMBOC} is unit-power PSD of spreading time series 1000.

An analysis of Equation 6 reveals that the TMBOC(6,1,4/33) spreading time series leads to the desired MBOC(6,1,1/11) PSD.

In alternate embodiments, other implementations may be used to give rise to the desired MBOC(6,1,1/11) PSD. In an embodiment in which there is an even split of signal power between the data component and the pilot component, a spreading time series may include all BOC(1,1) spreading symbols in the data spreading time series. The pilot spreading time series may include six BOC(6,1) spreading symbols per 33 chips with the rest being BOC(1,1) spreading symbols. As would be appreciated by persons skilled in the relevant art(s), such an embodiment is another TMBOC implementation. Such an embodiment would give rise to a power spectral density that may be derived as:

$$\begin{matrix}{G}_{Pilot} ( f ) = \frac{9}{11} {G}_{BOC ( 1 , 1 )} ( f ) + \frac{2}{11} {G}_{BOC ( 6 , 1 )} ( f ) \\ {G}_{Data} ( f ) = {G}_{BOC ( 1 , 1 )} ( f ) \\ {G}_{TMBOC} ( f ) = \frac{1}{2} {G}_{Pilot} ( f ) + \frac{1}{2} {G}_{Data} ( f ) \\ = \frac{10}{11} {G}_{BOC ( 1 , 1 )} ( f ) + \frac{1}{11} {G}_{BOC ( 6 , 1 )} ( f )\end{matrix} \qquad Equation 7$$

As shown by Equation 7, such an embodiment would give rise to an MBOC(6,1,1/11) PSD that is identical to the PSD expressed in Equation 6 for an implementation described in reference to FIG. 10. In yet another TMBOC embodiment, the total power of the GPS signal may be split evenly again between the data and pilot components and three BOC(6,1) symbols would be placed in each of the data and pilot spreading time series for every 33 chips, with the rest of the chips having BOC(1, 1) spreading symbols. The unit-power PSD of such spreading time series may derived as:

$$\begin{matrix}{G}_{Pilot} ( f ) = \frac{10}{11} {G}_{BOC ( 1 , 1 )} ( f ) + \frac{1}{11} {G}_{BOC ( 6 , 1 )} ( f ) \\ {G}_{Data} ( f ) = \frac{10}{11} {G}_{BOC ( 1 , 1 )} ( f ) + \frac{1}{11} {G}_{BOC ( 6 , 1 )} ( f ) \\ {G}_{MBOC} ( f ) = \frac{1}{2} {G}_{Pilot} ( f ) + \frac{1}{2} {G}_{Data} ( f ) \\ = \frac{10}{11} {G}_{BOC ( 1 , 1 )} ( f ) + \frac{1}{11} {G}_{BOC ( 6 , 1 )} ( f )\end{matrix} \qquad Equation 8$$

As shown by Equation 8, such an embodiment also gives rise to an MBOC(6,1,1/11) PSD. Thus, all three of the aforementioned embodiments give rise to the desired MBOC(6,1,1/11) PSD. The aforementioned embodiments are meant to be exemplary embodiments. As would be apparent to those skilled in the relevant art(s), the total power of a GNSS signal may be split in other ways without departing from the scope and spirit of the invention. Moreover, the time multiplexed spreading time series described above are also meant to be exemplary embodiments. As would also be apparent to those skilled in the relevant art(s), other combinations of spreading symbols may also be used to form a time multiplexed spreading time series without departing from the scope and spirit of the invention.

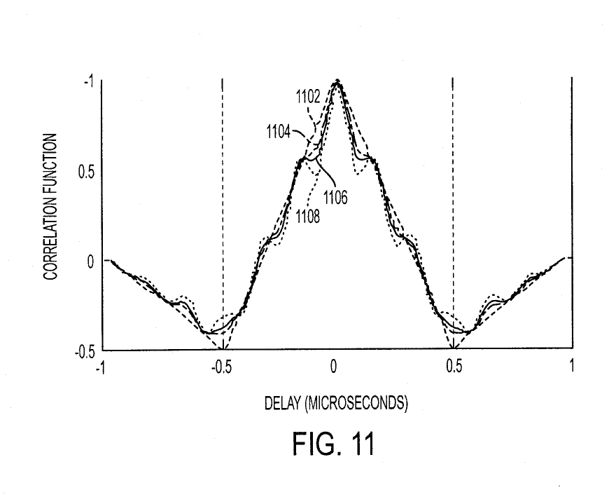

FIG. 11 shows waveforms 1102, 1104, 1106, and 1108 corresponding to the autocorrelation functions of different spreading time series. Waveform 1102 corresponds to spreading time series including all BOC(1,1) spreading symbols. Waveform 1104 corresponds to a spreading time series including three BOC(6,1) spreading symbol for every 33 spreading symbols in both the data and pilot components, the rest of the spreading symbols being BOC(1,1) spreading symbols, as described with reference to the derivation of Equation 8. Waveform 1106 corresponds to a TMBOC(6,1,4/33) spreading time series as described with reference to FIG. 10. Waveform 1108 corresponds to a spreading time series including six BOC(6,1) spreading symbols for every 33 spreading symbols on the pilot component, the rest of the spreading symbols are BOC(1,1) spreading symbols, as described with reference to the derivation of Equation 7. As shown in FIG. 11, a function peak of waveform 1106 is narrower than the function peak for waveform 1102 while retaining widths at values of 0.5 and at zero crossing that are generally similar to waveform 1102. Thus, in addition to adding high frequency content to the pilot component for improved signal tracking, such an embodiment also leads to improved autocorrelation properties, which, as described above, may lead to more accurate decoding at a receiver in CDMA systems, such as but not limited to GNSS applications.

In addition to one or more data spreading time series and one or more pilot time series, a DSSS signal may also include a data spreading code (to be included in one or more data components of the DSSS signal) and a pilot spreading code (to be included one or more pilot components of the DSSS signal). A spreading code, as described herein, typically includes a series of binary values. For example, this series of binary values may also be multiplied with the encoded data signal at multiplier 110a in FIG. 1. The spreading code is typically included in the DSSS signal to improve autocorrelation and/or cross-correlation properties of the DSSS signal. In particular, the spreading code may result in the DSSS signal having improved autocorrelation and/or cross-correlation sidelobes.

The effects of a spreading code, however, are often dependent on the spreading time series. In other words, a particular spreading code that improves the performance of a first DSSS signal having a first spreading time series may not improve the performance of a second DSSS signal having a second spreading time series. Thus, to improve the performance of a DSSS signal including a spreading time series (such as the TMBOC(6,1,4/33)) an optimal spreading code may be determined. In such an embodiment, the spreading code(s) are determined based at least on the spreading time series. In other words, the spreading code(s) that are included are optimized specifically for the spreading time series. For example, for a DSSS signal including a TMBOC(6,1,4/33) spreading time series, data and pilot spreading code(s) may be optimized specifically for the TMBOC(6,1,4/33) spreading time series. In such an embodiment, the data and pilot spreading code(s) may be optimized such that the a DSSS signal including the TMBOC(6,1,4/33) spreading time series has improved autocorrelation performance and/or cross-correlation performance with other DSSS signals.

Thus, in an embodiment, a spreading code is optimized for a given spreading time series. In other words, the spreading code is determined so as to provide the maximum improvement in autocorrelation and cross-correlation properties for a DSSS signal including the given spreading time series. Similarly, a spreading time series may be optimized for a given spreading code. In such an embodiment, the types of spreading symbols and the locations of different spreading symbols are determined so as to provide the maximum improvement in autocorrelation and cross-correlation properties for a DSSS signal including the given spreading code.

In a further embodiment, the spreading code and the spreading time series of a DSSS signal are determined together. In such an embodiment, the spreading code and the spreading time series are not determined independently. In an embodiment, determining the spreading code and the spreading time series together results in a DSSS signal having better autocorrelation and/or cross-correlation properties compared to a DSSS signal in which the spreading code is optimized based on a given spreading time series or vice versa.

Determining a spreading code and a spreading time series together may involve an iterative process in which a spreading time series is initially defined. An optimal spreading code may then be determined for that spreading time series. An optimal spreading time series may then, in turn, be determined for the optimal spreading code. As would be appreciated by those skilled in the relevant art(s), such a process may continue until an optimal spreading code and spreading time series combination is determined. Moreover, as would be apparent to those skilled in the relevant art(s), such an iterative process may also begin with an initially defined spreading code.

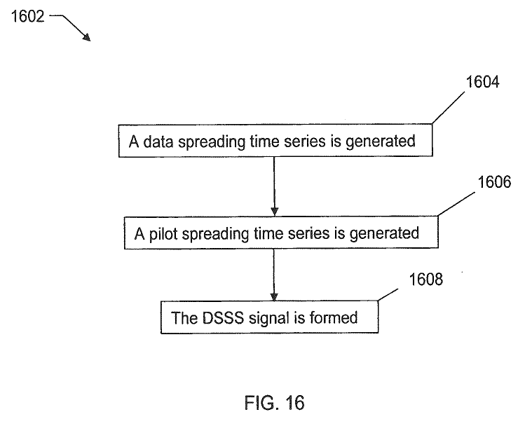

The operation of the invention as described above is represented by flowchart 1602 illustrated in FIG. 16. Other structural and operational embodiments will be apparent to persons skilled in the relevant art(s) based on the following discussion. The steps shown in FIG. 16 do not necessarily have to occur in the order shown. Flowchart 1602 shall now be described.

In step 1604, a data spreading time series including a first spreading symbol is generated.

In step 1606, a pilot spreading time series including a second spreading symbol and a third spreading symbol is generated. The second spreading symbol and the third spreading symbol are different. In an embodiment, the first spreading symbol and second spreading symbol are the same.

In another embodiment, at least one of the first, second, and third spreading symbols is a BOC spreading symbol. In a further embodiment, both the first and second spreading symbols are BOC(1,1) spreading symbols. In still a further embodiment, the third spreading symbol is a BOC(6,1) spreading symbol.

In step 1608, the DSSS signal is formed. The DSSS signal is formed based at least on the data spreading time series and the pilot spreading time series. In an embodiment, the DSSS signal has carrier frequency of 1575.42 MHz.

In an embodiment, at least one of the first spreading symbol, the second spreading symbol, and the third spreading symbol is selected based at least a cross-correlation sidelobe or an autocorrelation sidelobe of the DSSS signal. For example, the third spreading symbol may be selected to be a BOC(6,1) spreading symbol instead of a BOC(1,1) spreading symbol because the BOC(6,1) spreading symbol results in a DSSS signal that has a lower autocorrelation sidelobe or cross-correlation sidelobe.

Moreover, a location of at least one the first spreading symbol, the second spreading symbol, and the third spreading symbol may be selected based at least on a cross-correlation sidelobe or an autocorrelation sidelobe of the DSSS signal. For example, the third spreading symbol may be located at the 1st chip, 5th chip, 7th chip, and 30th chip of every 33 chips of the pilot spreading time series instead of other locations because such a spreading time series results in a DSSS signal that has a relatively low autocorrelation sidelobe or cross-correlation sidelobe compared to DSSS signals with the third spreading symbol located in other chips.

In another embodiment, at least one the first spreading symbol, the second spreading symbol, and the third spreading symbol is selected based on a power spectral density of the DSSS signal. For example, the third spreading symbol may be selected to be a BOC(6,1) spreading symbol over a BOC(4,1) spreading symbol because including the BOC(6,1) spreading symbol results in the DSSS signal having more high frequency content compared to the case where the third spreading symbol is a BOC(4,1) spreading symbol.

In another embodiment, a data spreading code and a pilot spreading code are generated. The data spreading code and the pilot spreading code are configured to improve an autocorrelation and/or a crosscorrelation performance of the DSSS signal. The data spreading code is determined at least based on data spreading time series. The pilot spreading code is determined at least based on the pilot spreading time series. For example, in an embodiment where the DSSS signal includes a TMBOC(6,1,4/33) spreading time series, the data spreading code and pilot spreading may be optimized based on the data and pilot components of the TMBOC(6,1,4/33) spreading time series so as to provide maximum benefit to an autocorrelation performance and/or cross-correlation performance with other DSSS signals.

### Example Receiver Implementations

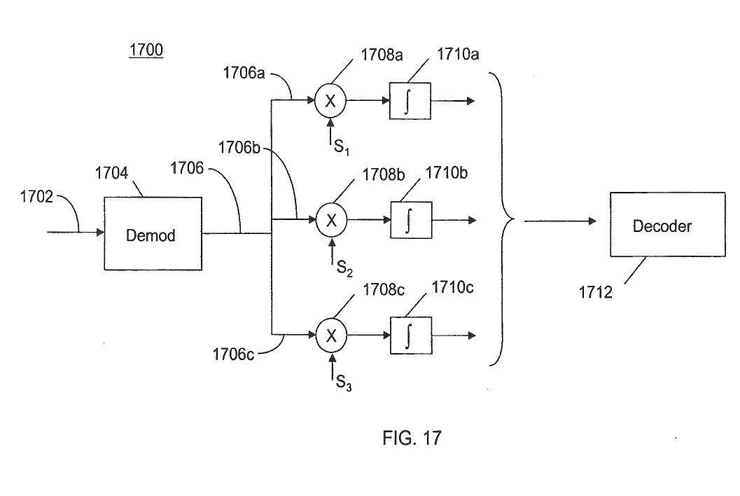

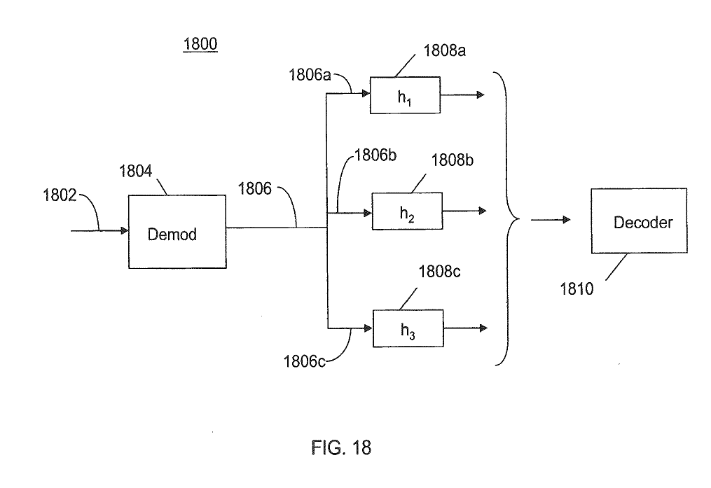

FIGS. 17 and 18 show example receiver implementations, according to embodiments of the present invention. FIG. 17 shows a correlation receiver 1700. Correlation receiver 1700 includes a demodulator 1704, multipliers 1708a-c, integrators 1710a-c, and a decoder 1712. Correlation receiver 1700 receives a signal 1702. Demodulator 1704 demodulates a received signal 1702 to recover a baseband signal 1706. Multipliers 1708a, 1708b, and 1708c multiply signals S₁, S₂, and S₃ with signals 1706a, 1706b, and 1706c respectively. In an embodiment, signals 1706a-c are copies of baseband signal 1706. Integrators 1710a-c integrate the outputs of multipliers 1708a-c over chip period T_{c}. Thus, multipliers 1708a-c and integrators 1710a-c effectively perform separate dot products between signals 1706a-c and signals S₁, S₂, and S₃ as defined by Equation 2 described above. A correlator may also be used to perform dot products between signals. Thus, multiplier/integrator pairs 1708a and 1710a, 1708b and 1710b, and 1708c and 1710c may be replaced by three correlators in alternate implementations. Decoder 1712 infers an intended message based outputs of integrators 1710a-c.

In an embodiment, each of S₁, S₂, and S₃ are orthogonal signals. In a further embodiment, signals S₁, S₂, and S₃ are different spreading time series. For example, signal S₁ may be a spreading time series including all BOC(1,1) spreading symbols, signal S₂ may be a spreading time series including all BOC(12,1) spreading symbols, and signal S₃ may be spreading time series including all BOC(6,1) spreading symbols. The BOC(1,1), BOC(12,1), and BOC(6,1) spreading symbols define an orthogonal set of spreading symbols since each spreading symbol in the set is orthogonal to all other spreading symbols in the set. As would be appreciated by those skilled in the relevant art(s), other sets of orthogonal spreading symbols exist and may be used in correlation receiver 1700 without departing from the scope and spirit of the invention.

In an embodiment, signal 1706 includes a TMBOC(6,1,4/33) spreading time series, as described with reference FIG. 10. The pilot component of the TMBOC(6,1,4/33) spreading time series includes both BOC(1,1) and BOC(6,1) spreading symbols. Through the use of multipliers 1708a-c and integrators 1710a-c, copies of the pilot component of signals 1706a-c are dotted with signals S₁, S₂, and S₃. Since all of the spreading symbols that make up signal S₂ (i.e., BOC(12,1) spreading symbols) are orthogonal to both BOC(1,1) and BOC(6,1) spreading symbols, the incremental output of integrator 1710b will be zero over the duration of signal 1706. Similarly, the incremental output of integrator 1710a will be non-zero only over the parts of baseband signal 1706 that include BOC(1,1) spreading symbols. The incremental output of integrator 1710c will be non-zero only over the parts of baseband signal 1706 that include BOC(6,1) spreading symbols.

In an embodiment, the weight of each type of spreading symbol may be changed by setting one or more outputs of integrators 1710a-c to zero. For example, correlation receiver 1700 may be configured to decrease the weight of BOC(6,1) spreading symbols (or equivalently increase the weight of the BOC(1,1) spreading symbols) that are processed by decoder 1712 by setting the incremental output of integrator 1710c to zero during some chip periods. In such an embodiment, all BOC(1,1) spreading symbols of TMBOC(6,1,4/33) spreading time series would be processed. In contrast, only a subset of all of the BOC(6,1) spreading symbols would be processed.

Moreover, the weight of each type of spreading symbol may also be changed by multiplying the incremental output of one or more integrators of integrators 1710a-1710c by a coefficient. For example, to increase the weight of BOC(6,1) spreading symbols, the incremental output of integrator 1710c may be multiplied by a coefficient greater than 1 and/or the incremental outputs of integrators 1710a and 1710 may be multiplied by coefficients less than one. In the embodiment in which correlation receiver 1700 includes correlators instead of multiplier/integrator pairs, such a technique for weighting may also be applied to the outputs of one or more correlators, as would be apparent to those skilled in the relevant art(s).

To completely discard all BOC(6,1) spreading symbols, the output of integrator 1710c may be set to zero for all chip periods. Alternatively, the incremental output of integrator 1710a may be set to zero for some or all chip periods to increase the weight of the BOC(6,1) spreading symbol.

FIG. 17 shows correlation receiver 1700 with three different multipliers 1708a-c and three different integrators 1710a-c associated with three orthogonal signals S₁, S₂, and S₃. However, as would be apparent to those skilled in the relevant art(s), correlation receiver 1700 may have any number of orthogonal signals and a corresponding number of multiplier/integrator or correlator pairs without departing from the scope and spirit of the invention. In a further embodiment, correlation receiver 1700 may be configured to process only low frequency components of a received signal by setting all incremental outputs of integrators corresponding to certain spreading symbols to zero. For example, correlation receiver 1700 may be configured to process only low frequency components by setting the incremental outputs of all integrators associated with spreading symbols (expressed as BOC(n,m)) that have an n value greater than 2 to zero. Processing only low frequency components may be beneficial to processing that is done at a relatively low sampling rate. Those skilled in the relevant art(s) would appreciate that the reverse can be done to process only the high frequency components of baseband signal 1706. Processing only high frequency components may enhance signal tracking performance. The weighting of certain spreading symbols effectively results in an autocorrelation function of a received signal being different than the corresponding cross-correlation function of the received signal and the received signal processed such that one or more spreading symbols are weighted.

Moreover, the weighting of different spreading symbols of a baseband signal may be implemented similarly in other types of receivers. For example, FIG. 18 shows a matched filter receiver 1800, according to an embodiment of the present invention. Matched filter receiver 1800 includes a demodulator 1804, filters 1808a-c, and a decoder 1810. Demodulator 1804 and decoder 1810 are generally similar to demodulator 1704 and decoder 1712 described with reference to FIG. 17. A baseband signal 1806 is the result of demodulation by demodulator 1804. Signals 1806a-c are applied to filters 1808a-c. In an embodiment, signals 1806a-c are copies of baseband signal 1806. Baseband 1806 includes a spreading time series such as the TMBOC(6,1,4/33) spreading time series described with reference to FIG. 10. As shown in FIG. 18, filters 1808a-c have impulse responses h₁, h₂, and h₃. In an embodiment, impulse responses h₁-h₃ are time-reversed and delayed versions of signals S₁, S₂, and S₃, as described with reference to FIG. 17. Filters 1808a-c convolve signals 1806a-c with impulse responses h₁-h₃, respectively. As would be appreciated by those skilled in the art(s), filters 1808a-c may be configured such that the convolution of signals 1806a-c with impulse responses h₁-h₃ result in outputs that are substantially identical to outputs of integrators 1710a-c, as described with reference to FIG. 17. In other words, convolving signals 1806a-c with impulse responses h₁-h₃ results in performing separate dot products with signals 1806a-c and the corresponding signal S₁-S₃. Thus, in order to weigh a spreading symbol, one or more incremental outputs of filters 1808a-c may be set to zero at certain chip periods or during all chip periods of baseband signal 1706. Moreover, the incremental outputs of one or more filters of filters 1808a-c may also be multiplied by a coefficient to weigh one or more spreading symbols. As would be appreciated by those skilled the relevant art(s), this allows matched filter receiver 1800 to be configured to process only low frequency components or only high frequency components of a received signal.

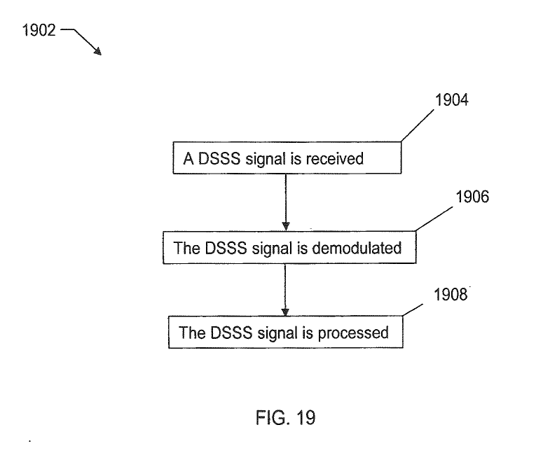

The operation of the invention as described above is represented by flowchart 1902 illustrated in FIG. 19. Other structural and operational embodiments will be apparent to persons skilled in the relevant art(s) based on the following discussion. The steps shown in FIG. 19 do not necessarily have to occur in the order shown. Flowchart 1902 shall now be described.

In step 1904, a DSSS signal is received. The DSSS signal includes a data component formed according to a data spreading time series and a pilot component formed according to a pilot spreading time series. The data spreading time series includes a first spreading symbol and the pilot spreading time series includes a second spreading symbol and a third spreading symbol. The second spreading symbol and the third spreading symbol are different.

In step 1906, the DSSS signal is demodulated. In an embodiment, demodulation of the DSSS signal results in a baseband signal.

In step 1908, the DSSS signal is processed. The DSSS signal is processed such that one or more spreading symbols are weighted. In an embodiment, the first spreading symbol is weighted lower. In an embodiment, the first and second spreading symbols are the same. In an alternative embodiment, the third spreading symbol is weighted lower. In an embodiment, only high frequency content or low frequency content of the DSSS signal is processed.

In another embodiment, weighting is done by setting incremental outputs of one or more integrators or correlators in a correlation receiver to zero for one or more chip periods. In a further embodiment, a spreading symbol is masked by setting an integrator or a correlator incremental output in a correlation receiver to zero for all chip periods of the received signal.

In an alternate embodiment, weighting is done by setting incremental outputs of one or more filters in a matched filter receiver to zero for one or more chip periods. In a further embodiment, a spreading symbol is masked by setting a filter incremental output in a correlation receiver to zero for all chip periods of the received signal.

In an embodiment, at least one of the first spreading symbol, the second spreading symbol, and the third spreading symbol is a binary offset carrier spreading symbol. In a further embodiment, the first and second spreading symbols are both BOC(1,1) spreading symbols and the third spreading symbol is a BOC(6,1) spreading symbol.

Example Performance Assessment

An important criterion in evaluating the performance of wireless signals is their performance in a multipath environment. In a multipath environment, multiple forms (i.e., phase shifted) of a transmitted signal arrive at a receiver at approximately the same time because of reflections along the signal path. Multipath performance herein will be evaluated based on an early-late performance processing model that includes a direct path signal version and a reflected path signal version. A multipath to direct path signal power ratio (MDR) is assumed to be constant with respect to the delay between the direct and reflected signals. Such a model does not provide a probability distribution of the reflected path delay or an attenuation value associated with each delay. However, the model does provide general insight into the performance of different spreading modulations in a multipath environment. In the performance tests conducted herein, an MDR of −6 dB was used and a receiver was assumed to have a four or six-pole Butterworth band-limiting filter with −3 dB points at the stated bandwidth (BW). The filter was assumed to be phase-equalized so that the group delay is constant. Non-coherent early-late processing (NELP) was used.

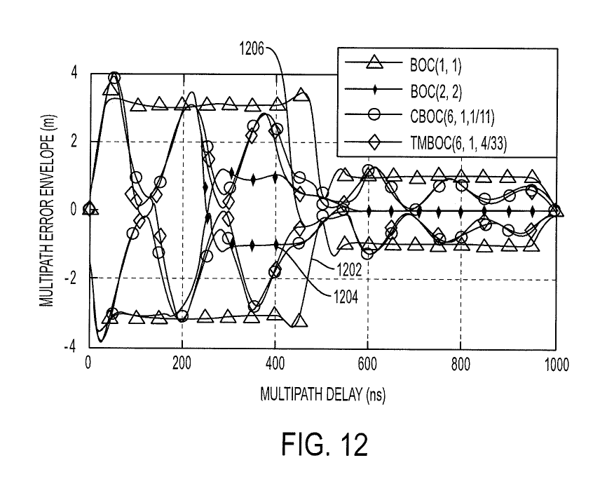

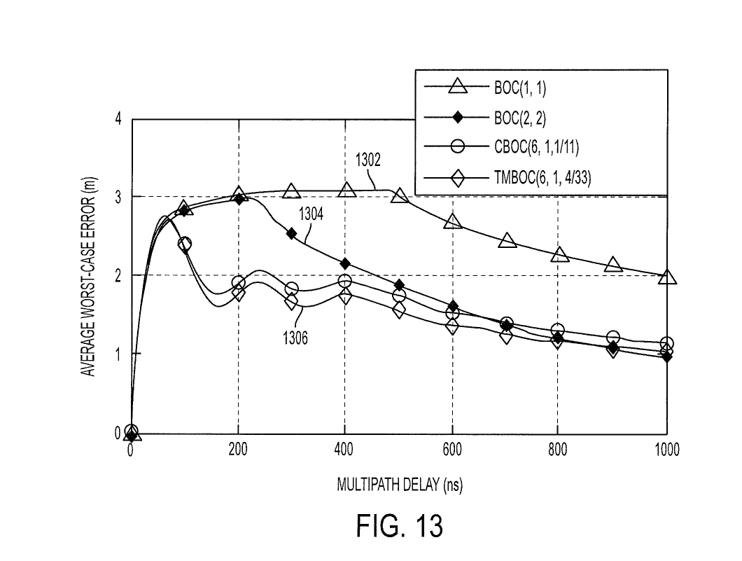

FIG. 12 shows a multipath error envelope for a receiver that has a 24 MHz pre-correlation (double-sided) bandwidth and narrow early-late spacing of 24.4 ns corresponding to a 0.025 fraction of a 1.023 MHz spreading time series chip rate. FIG. 12 includes waveforms 1202, 1204, and 1206. Waveform 1202 corresponds to a multipath error envelope for a BOC(1,1) spreading modulation. Waveform 1204 corresponds to a multipath error envelope for a BOC(2,2) spreading modulation. Waveform 1206 corresponds to a multipath error envelope for a TMBOC(6,1,4/33) spreading modulation, as discussed with reference to FIG. 10. As shown in FIG. 12, waveform 1206 has the best performance (i.e., smallest error envelope) for most multipath delay times. FIG. 13 shows waveforms 1302, 1304, and 1306 corresponding to BOC(1,1), BOC(2,2), and TMBOC(6,1,4/33) spreading modulations, respectively. As discussed above, waveforms 1302, 1304, and 1306 indicate an average worst-case error based on the aforementioned model.

As shown in FIG. 13, waveform 1306 has the lowest average worst-case error for relatively short multipath delays. As the multipath delay increases waveform 1306 becomes generally similar to waveform 1304 and remains below waveform 1302. Moreover, it has also been shown that the TMBOC(6,1,4/33) spreading modulation also outperforms the BOC(1,1) and BOC(2,2) spreading modulations in other early-late models. For example, in tests with a narrower early-late spacing of 12 ns, wider early-late spacing of 48.9 ns, and with a narrower pre-correlation (double-sided) bandwidth of 12 MHz the TMBOC(6,1,4/33) spreading modulation outperforms the BOC(1,1) and the BOC(2,2) spreading modulations.

In addition to early-late processing, double-delta multipath mitigation processing is another technique that may be used to demodulate spreading modulations. In an embodiment, early-late processing is done through the use of two correlators (one early correlator and one late correlator for the direct and reflected received signals, respectively) that together analyze an autocorrelation function of the received signal. In such an embodiment, double-delta processing refers to processing using two early correlators and two late correlators to analyze an autocorrelation function of the received signal, and to determine an output based on the results of each of the correlators. The double-delta processing described herein refers to a technique in which each edge of the incoming signal is processed.

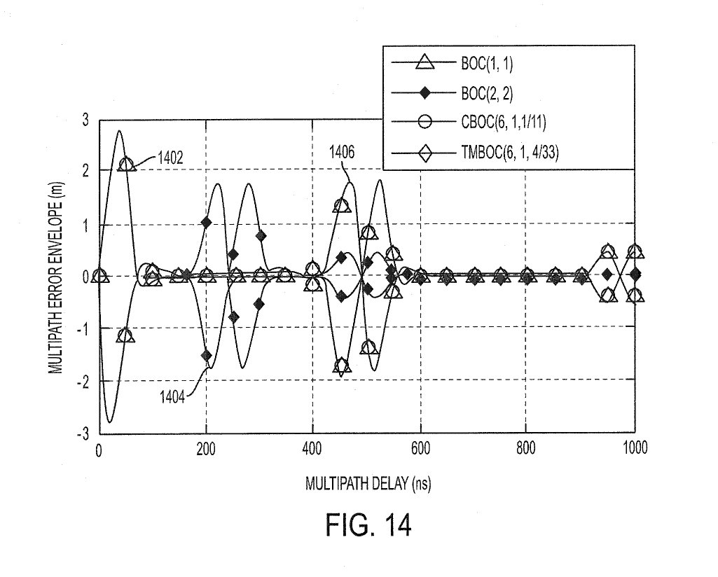

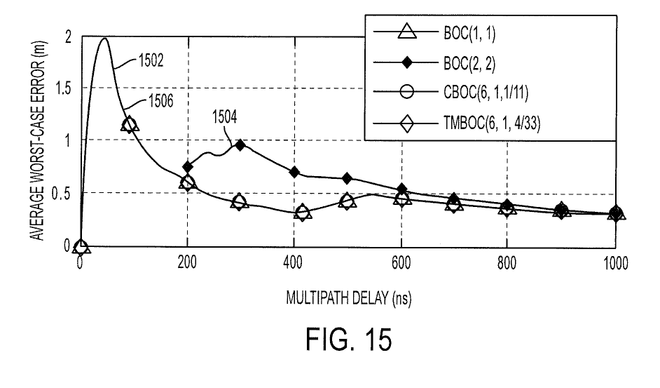

In an embodiment, higher frequency spreading symbols (e.g., BOC(6,1)) are masked in the receiver replica so that only the lower frequency spreading symbols (e.g., BOC(1,1)) are processed in a masked symbol replica (MSR) process. The resulting code tracking signal to noise ratio (SNR) is generally similar to the case where the BOC(6,1) signals are processed. For example, the loss in SNR could be 0.4 dB, 0.6 dB, or 0.9 dB depending on the spreading modulation used. FIGS. 14 and 15 show the multipath error envelope functions and average worst-case error functions for signals that are processed according to the double delta processing technique with the multipath considerations the similar to those mentioned above. The model used here assumes a receiver BW of 24 MHz, an inner early-late spacing of 24.4 ns, and an outer early-late spacing of 48.9 ns. FIG. 14 shows waveforms 1402, 1404, 1406 corresponding to multipath error envelopes for BOC(1,1), BOC(2,2), and TMBOC(6,1,4/33) spreading modulations, respectively. FIG. 15 shows waveforms 1502, 1504, 1506 corresponding to average worst case errors for BOC(1,1), BOC(2,2), and TMBOC(6,1,4/33) spreading modulations, respectively. As shown in FIGS. 14 and 15, TMBOC(6,1,4/33) and BOC(1,1) spreading modulations yield generally similar multipath error envelopes and average worst-case errors, with both outperforming the BOC(2,2) implementation. Moreover, a comparison of FIGS. 12 and 13 to FIGS. 14 and 15 reveals that double delta processing (with MSR in the TMBOC(6,1,4/33) case) outperforms early-late processing both in terms of the multipath error envelope and the average worst-case error.

Thus, multipath performance tests show that a TMBOC(6,1,4/33) spreading time series, when processed by early-late processing, performs better than a BOC(1,1) spreading time series and a BOC(2,2) spreading time series. In the case where the signal is processed using double delta processing, a TMBOC(6,1,4/33) spreading time series obtains performance comparable to a BOC(1,1) spreading time series and better than a BOC(2,2) spreading time series.

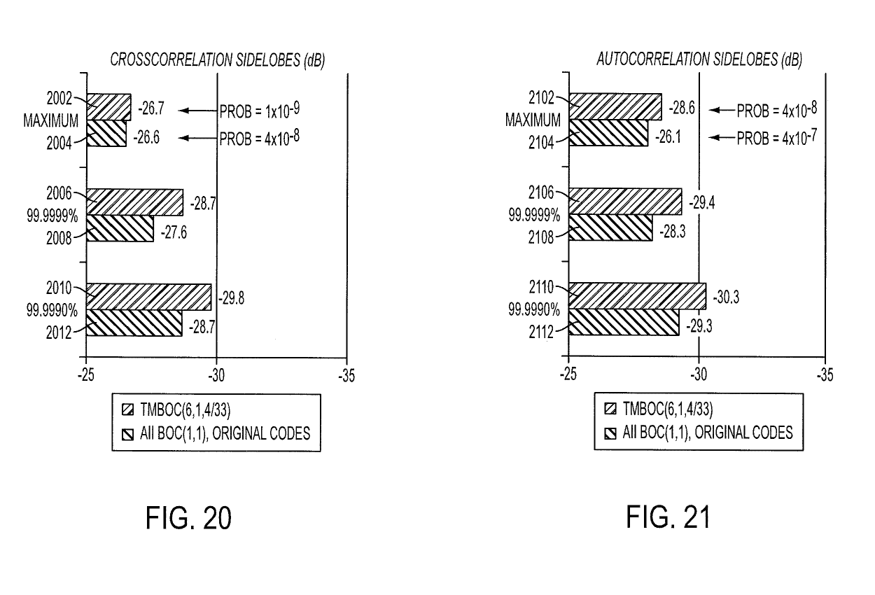

As described above, the placement of high frequency spreading symbols (e.g., BOC(6,1) spreading symbols) in the TMBOC(6,1,4/33) spreading series can affect the autocorrelation and cross-correlation properties of the resulting signal. FIG. 20 shows graphs 2002, 2006, and 2010 corresponding to cross-correlation sidelobes for the TMBOC(6,1,4/33) spreading time series as described with reference to FIG. 10, and graphs 2004, 2008, and 2012 corresponding to cross-correlation sidelobes for a spreading time series including all BOC(1,1) spreading symbols. As shown in FIG. 20, the maximum cross-correlation level for a TMBOC(6,1,4/33) spreading time series is reduced by 0.1 dB compared to the BOC(1,1) spreading time series and a probability of occurrence is reduced by a factor of 40.

FIG. 21 shows graphs 2102, 2106, and 2110 corresponding to autocorrelation sidelobes for the TMBOC(6,1,4/33) spreading time series as described with reference to FIG. 10, and graphs 2104, 2108, and 2112 corresponding to autocorrelation sidelobes for a spreading time series including all BOC(1,1) spreading symbols. As shown in FIG. 21, the maximum autocorrelation level for a TMBOC(6,1,4/33) spreading time series is reduced by 0.1 dB compared to the BOC(1,1) spreading time series and a probability of occurrence is reduced by a factor of 20.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A direct sequence spread spectrum (DSSS) signal, comprising:
a time multiplexed spreading time series, including:
a data spreading time series comprising at least a first spreading symbol; and
a pilot spreading time series, comprising at least a second spreading symbol and a third spreading symbol, wherein the second spreading symbol and the third spreading symbol are different.

2. The DSSS signal of claim 1, wherein the first spreading symbol is the same as the second spreading symbol.

3. The DSSS signal of claim 1, wherein at least one of the first spreading symbol and the second spreading symbol is a BOC(1,1) spreading symbol.

4. The DSSS signal of claim 1, wherein the third spreading symbol is a BOC(6,1) spreading symbol.

5. The DSSS signal of claim 1, wherein the data spreading time series also includes a fourth spreading symbol.

6. The DSSS signal of claim 5, wherein the fourth spreading symbol is the same as the third spreading symbol.

7. The DSSS signal of claim 1, wherein the data spreading time series is expressed as:
$${s}_{d} ( t ) = {\sum }_{k = - ∞}^{∞} {g}_{kd} ( t - {kT}_{c} ) ,$$
wherein s_{d} (t) is the data spreading time series.
{h_{kd}(t−kT_{c})} is a series or data spreading symbols, and
k is a variable of indexing.

8. The DSSS signal of claim 1, wherein the pilot spreading time series is expressed as:
$${s}_{p} ( t ) = {\sum }_{k = - ∞}^{∞} {g}_{kp} ( t - {kT}_{c} ) ,$$
wherein sₚ(t) is the pilot spreading time series,
{hₖₚ(t−kT_{c} } is a series of pilot spreading symbols, and
k is a variable of indexing.

9. The DSSS signal of claim 1, further comprising:
a pseudo-random code.

10. The DSSS signal of claim 1, wherein a center frequency of the DSSS signal is substantially 1575.42 MHz.

11. The DSSS signal of claim 1, wherein the pilot spreading time series includes a plurality of chips, wherein 4 of every 33 chips of the pilot spreading time series includes the third spreading symbol.

12. The DSSS signal of claim 11, wherein the third spreading symbol is located at a 1st chip, a 5th chip, a 7th chip, and a 30th chip of every 33 chips in the pilot spreading time series.

13. The DSSS signal of claim 11, wherein a data component of the DSSS signal includes substantially 25% total signal power of the DSSS signal and a pilot component of the DSSS signal includes substantially 75% total signal power of the DSSS signal.

14. The DSSS signal of claim 11 wherein the first spreading symbol and second spreading symbol are the same.

15. The DSSS signal of claim 11, wherein the first spreading symbol is a BOC(1,1) spreading symbol, the second spreading symbol is a BOC(1,1) spreading symbol, and the third spreading symbol is a BOC(6,1) spreading symbol.

16. The DSSS signal of claim 1, wherein the pilot spreading time series includes a plurality of chips, wherein 6 of every 33 chips of the pilot spreading time series includes the third spreading symbol.

17. The DSSS signal of claim 16, wherein a data component of the DSSS signal includes substantially 50% total signal power of the DSSS signal and a pilot component of the DSSS signal includes substantially 50% total signal power of the DSSS signal.

18. The DSSS of claim 1, wherein the pilot spreading time series includes a plurality of chips, wherein 3 of every 33 chips of the pilot spreading time series is the third spreading symbol, wherein the data spreading time series includes a plurality of chips, wherein 3 of every 33 chips of the data series is the third spreading symbol.

19. The DSSS signal of claim 18, wherein a data component of the signal includes substantially 50% total signal power of the signal and a pilot component of the signal includes substantially 50% total signal power of the signal.

20. The DSSS signal of claim 1 wherein the signal has more high frequency content than a signal modulated with the first spreading symbol alone.

21. The DSSS signal of claim 1, wherein the third spreading symbol in the pilot spreading time series results in a baseband component of the DSSS signal having greater high frequency content than if the pilot component only included the second spreading symbol.

22. The DSSS signal of claim 1, wherein the third spreading symbol in the pilot spreading time series results in the DSSS signal having a lower autocorrelation sidelobe and a lower cross-correlation with other DSSS signals than if the pilot component only included the second spreading symbol.

23. The DSSS signal of claim 1, further comprising:
a spreading code, including:
a data spreading code; and
a pilot spreading code;
wherein the spreading code and the time multiplexed spreading time series are determined together so that the DSSS signal has an improved autocorrelation or an improved cross-correlation with other DSSS signals relative to a DSSS signal that includes a spreading time series including only one spreading symbol.

24. A method of generating a direct sequence spread spectrum (DSSS) signal, comprising:
(1) generating a data spreading time series comprising at least a first spreading symbol;
(2) generating a pilot spreading time series comprising at least a second spreading symbol and a third spreading symbol, wherein the second spreading symbol and the third spreading symbol are different; and
(3) forming a DSSS signal based at least on the data spreading time series and the pilot spreading time series.

25. The method of claim 24, wherein first spreading symbol and the second spreading symbol are the same.

26. The method of claim 25, wherein at least one of the first spreading symbol, the second spreading signal, and the third spreading symbol is a binary offset carrier spreading symbol.

27. The method of claim 25, wherein at least one of the first spreading symbol and the second spreading signal is a BOC(1,1) spreading symbol.

28. The method of claim 24, wherein the third spreading symbol is a BOC(6,1) spreading symbol.

29. The method of claim 24, further comprising:
selecting at least one of the first spreading symbol, the second spreading symbol, and the third spreading symbol based on at least a cross-correlation sidelobe or an autocorrelation sidelobe of the DSSS signal.

30. The method of claim 24, further comprising:
selecting a location of at least one of the first spreading symbol, the second spreading symbol, and the third spreading symbol based at least on a cross-correlation sidelobe or an autocorrelation sidelobe of the DSSS signal.

31. The method of claim 24, further comprising:
selecting at least one of the first spreading symbol, the second spreading symbol, and the third spreading symbol based on a power spectral density of the DSSS signal.

32. The method of claim 24, wherein a center frequency of the DSSS signal is 1575.42 MHz.

33. The method of claim 24, further comprising:
generating a data spreading code and a pilot spreading code;
wherein the DSSS signal is framed based at least on the data spreading time series, the pilot spreading time series, the data spreading code, and the pilot spreading code, wherein the data spreading code and pilot spreading code are configured to improve an autocorrelatien of the DSSS signal or improve a cross-correlation of the DSSS signal with other DSSS signals, wherein the data-spreading code is determined based on at least the data spreading time series and the a pilot spreading code is determined based on at least the pilot spreading time series.
